(19) United States
(12) Patent Application Publication
(10) Pub. No.: US 2022/0114265 A1
(43) Pub. Date: Apr. 14, 2022

(54) UNIFIED VIEWING OF ROLES AND PERMISSIONS IN A COMPUTER DATA PROCESSING SYSTEM

(71) Applicant: Google LLC, Mountain View, CA (US)

(72) Inventors: Carla Riggi, Mountain View, CA (US); Lauren Madigan, Mountain View, CA (US); Lara Harrow, Mountain View, CA (US)

(73) Assignee: Google LLC, Mountain View, CA (US)

(21) Appl. No.: 17/066,447

(22) Filed: Oct. 8, 2020

(51) Int. Cl. G06F 21/60; G06F 21/62

(52) U.S. Cl. CPC G06F 21/604; G06F 2221/2141; G06F 2221/2145; G06F 21/6218

(57) ABSTRACT

A system and computer program product for the unified viewing of roles and permissions includes selecting an end user accessing data in a data processing system and determining an assigned role for the end user. The assigned role may then be deconstructed into a hierarchy of nested roles, and, for each of the nested roles, corresponding permissions may be determined. Thereafter, for each of the corresponding permissions, dependent other permissions may be identified. Finally, a dashboard user interface may be generated and displayed to as to include both the hierarchy of nested roles and also the listing the corresponding permissions along with the identified dependent other permissions.

### TECHNICAL FIELD

The present disclosure relates to the field of role and permissions administration in a computer data processing system.

### BACKGROUND

Permissions refer to the access control imposed upon individuals and classifications of individuals seeking to access either or both of data and functionality of a computer program. In its simplest form, permissions are governed by the entry of a user identifier and password presented during an authentication process in response to which the end user may then be granted access to the entirety of the application and data—an all-in access control model. In more complex arrangements, after authentication a lookup table may be consulted in order to determine which records or functions should be accessible to the end user. In even more complex arrangements, once authenticated, every attempt by the end user to access a function may be compared to an access control list (ACL) dictating whether or not the end user is able to access the desired function (or corresponding data). Finally, in even yet further a complex arrangement, access to every record may be controlled by a corresponding ACL so as to provide record level granularity of permissions.

For a simple deployment of an application to just a handful of end users, permissions-based access control can suffice. But, for a more robust deployment of dozens, hundreds or even thousands of end users, assigning permissions to each individual end user can be tedious, error prone and not realistic. As such, a discrete set of roles may be defined and associated permissions attached to each of the roles. Then, for every new end user registered to access the computer program, one of the roles may be associated with the end user so as to automatically assign the corresponding permissions to the end user. As well, as different permissions change for a role, all associated end users for the role automatically receive the change in permissions, thus greatly simplifying the process of managing permissions amongst a large number of end users.

As the deployment of a computing system ages, multiple different administrators may assign multiple different roles to multiple different end users. As well, for some end users, an administrator may directly assign specific permissions so as to permit the end user to accomplish a specific organizational task requiring access permitted by the specific permissions. As it will be understood, tracking assigned permissions resulting from direct assignments and assigned roles can become quite the challenge. As well, in many instances, contradictions in permissions may result from conflicting permissions in different assigned roles to the same end user. Detecting actual permissions resulting from assigned roles, then, can be of paramount importance.

### SUMMARY

Examples of the present disclose address deficiencies of the art in respect to roles and permissions visualization and provide a novel and non-obvious method, system and computer program product for the unified viewing of roles and permissions. One aspect of the disclosure provides a method for the unified viewing of roles and permissions in a data processing system. The method includes, selecting, by data processing hardware, an end user accessing data in a data processing system. The method further includes determining, by the data processing hardware, an assigned role for the end user. The method also includes deconstructing, by the data processing hardware, the assigned role into a hierarchy of nested roles. The method further includes determining, by the data processing hardware, for each of the nested roles, corresponding permissions. For each of the corresponding permissions, the method includes identifying, by the data processing hardware, dependent other permissions, and generating and displaying, by the data processing hardware, a dashboard user interface displaying both the hierarchy of nested roles and also a listing of the corresponding permissions along with the identified dependent other permissions.

Implementations of the disclosure may include one or more of the following optional features. In some implementations the data processing system is a database driven application instance accessing a multiplicity of different data models for data in one or more underlying databases. Here, the permissions may include both instance-wide permissions for the application instance, and also model-specific permissions for specific ones of the data models. Optionally, the method further includes identifying, by the data processing hardware, at least one contradiction in permissions wherein an instance-wide permission is granted for one of the assigned role and nested roles that overrides a model-specific permission for another one of the assigned role and nested roles, and presenting, by the data processing hardware, an alert in the dashboard of the contradiction.

Another aspect of the disclosure provides a data analytics data processing system configured for unified viewing of roles and permissions. The system includes a host computing platform having one or more computers, each with memory and at least one processor. The system further includes a database management system coupled to the host computing platform. The database management system includes one or more databases accessible through a common data access interface. The system also includes a data analytics application executing in the memory of the host computing platform. The data analytics application includes a user interface providing a visualization of data analytics derived from database queries to the database management system through the common data access interface. The system further includes a unified roles and permissions viewing module comprising computer program instructions that, when executing in the memory of the host computing platform, is enabled to perform operations. One of the operations includes selecting an end user accessing data in the data analytics application Another operation includes determining an assigned role for the end user. Yet another operation includes deconstructing the assigned role into a hierarchy of nested roles. An additional operation includes determining for each of the nested roles, corresponding permissions. Another operation includes, for each of the corresponding permissions, identifying dependent other permissions. Another operation includes generating and displaying a dashboard in the user interface of the data analytics application, the dashboard displaying both the hierarchy of nested roles and also a listing of the corresponding permissions along with the identified dependent other permissions.

Implementations of the disclosure may include one or more of the following optional features. In some implementations, the data analytics application accesses a multiplicity of different data models for data in one or more underlying ones of the databases. Here, the permissions include both instance-wide permissions for the data analytics application, and also model-specific permissions for specific ones of the data models. Optionally, the program instructions further perform operations including identifying at least one contradiction in permissions, wherein an instance-wide permission is granted for one of the assigned role and nested roles that overrides a model-specific permission for another one of the assigned role and nested roles, and presenting an alert in the dashboard of the contradiction.

Another aspect of the disclosure provides a computer program product for the unified viewing of roles and permissions in a data processing system. The computer program product includes a computer readable storage medium having program instructions included therewith. The program instructions are executable by a device to cause the device to perform a method The method includes selecting an end user accessing data in a data processing system and determining an assigned role for the end user The method further includes deconstructing the assigned role into a hierarchy of nested roles. Another step of the method includes determining for each of the nested roles, corresponding permissions. For each of the corresponding permissions, the method includes identifying dependent other permissions, and generating and displaying a dashboard user interface displaying both the hierarchy of nested roles and also a listing of the corresponding permissions along with the identified dependent other permissions.

Implementations of the disclosure may include one or more of the following optional features. In some implementations, the data processing system is a database driven application instance accessing a multiplicity of different data models for data in one or more underlying databases. Here, the permissions may include both instance-wide permissions for the application instance, and also model-specific permissions for specific ones of the data models. In some examples, the method further includes identifying at least one contradiction in permissions wherein an instance-wide permission is granted for one of the assigned role and nested roles that overrides a model-specific permission for another one of the assigned role and nested roles, and presenting an alert in the dashboard of the contradiction.

The details of one or more implementations of the disclosure are set forth in the accompanying drawings and the description below. Other aspects, features, and advantages will be apparent from the description and drawings, and from the claims.

### DESCRIPTION OF THE DRAWINGS

The accompanying drawings, which are incorporated in and constitute part of this specification, illustrate examples of the disclosure and together with the description, serve to explain the principles of the disclosure. The examples illustrated herein are presently preferred, it being understood, however, that the disclosure is not limited to the precise arrangements and instrumentalities shown, wherein:

FIG. 1 is a pictorial illustration of a process for generating a unified view of roles and permissions for different models in a data analytics data processing system;

FIG. 2 is a schematic illustration of a data analytics data processing system configured for unified viewing of roles and permissions; and,

FIG. 3 is a flow chart illustrating a process for unified viewing of roles and permissions.

Like reference symbols in the various drawings indicate like elements.

### DETAILED DESCRIPTION

Examples of the disclosure provide for the generation of a unified view of roles and permissions for different models in a data analytics data processing system. In accordance with an aspect of the disclosure, within a data analytics application, different groups of end users can be identified along with corresponding roles assigned to each of the groups. The end users of each group are then determined so as to associate the corresponding role or roles of each group with each end user assigned to the group. As well, to the extent that one or more groups are nested within the group, the users associated with each nested group are determined so as to associate the corresponding role or roles of the group with each of the end users assigned to each nested group.

Finally, for each determined end user, the permissions of each associated role are identified in connection with a corresponding model for a database collection of the data analytics system so that a user interface may be presented for a selected one of the end users showing all permissions enjoyed by the selected end user in connection with specified ones of the models and also in connection with the entirety of the instance of the data analytics application irrespective of any particular one of the models. As part of the user interface, one or more conflicting permissions may be identified in which a permission has been granted to the selected end user which is dependent upon another permission which has not been granted to the end user. Likewise, a conflicting permission may be identified in the user interface which neuters the limitation of another permission, such as where one permission is model-specific and another similar permission dependent upon the other is not limited to any one of the models.

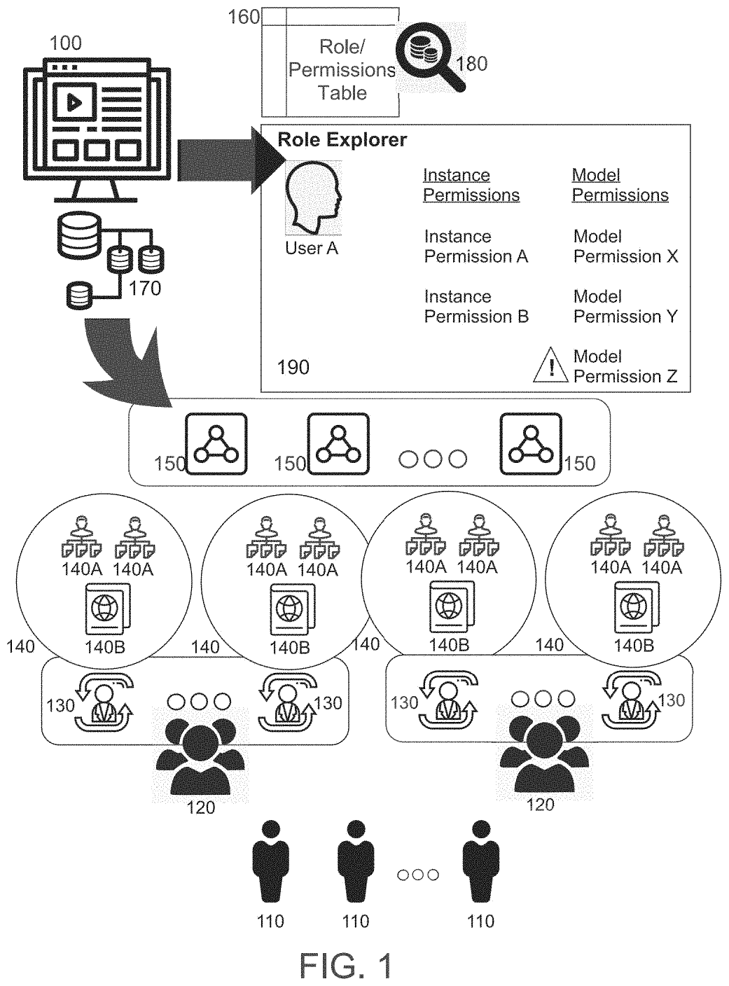

In further illustration, FIG. 1 pictorially shows a process for generating a unified view of roles and permissions for different models in a data analytics data processing system. As shown in FIG. 1, a database collection 170 of one or more database storage systems, including any combination of a relational database, object database, flat file database, table, list or other data structure, may be modeled according to one or more data models 150 accessible by a data analytics application 100 adapted to provide data analytics operations operable upon data in the database collection 170 through the issuance of one or more database queries by one or more end users 110. Access to the data and the underlying data analytics operations are limited by one or more permissions 140A that are specific to corresponding ones of the models 150, and also one or more instance-wide permissions 140B that are applicable to the instance of the data analytics application 100.

One or more groups 120 of the end users 110 may be defined for different combinations of the end users 110. Each of the groups 120 can be associated with one or more roles 130, with each of the roles 130 aggregating one or more of the permissions 140A, 140B so that those of the end users 110 belonging to a particular one of the groups 120 enjoys permissions 140A, 140B aggregated in one or more of the roles 130 assigned to the particular one of the groups 120. Notably, selected ones of the groups 120 may in of themselves, include one or more others of the groups 120 so as to form a nested grouping. In consequence, one or more of the end users 110 of one of the groups 120 may enjoy permissions 140A, 140B of a role 130 that has been assigned to another of the groups 120 in which the one of the groups 120 has been nested. The foregoing associations of permissions 140A, 140B, roles 130, groups 120 and end user 110 may be stored in respect to the data analytics application 100 in a table 160.

Importantly, owing to the potential nesting of the groups 120, one of the permissions 140A, 140B enjoyed by a corresponding one of the end users 110 may conflict with another of the permissions 140A, 140B of the corresponding one of the end users 110 in so far as one of the permissions 140A, 140B may be neuter limitations imposed by another of the permissions 140A, 140B, such as where one of the permissions 140A is model-specific and another of the permissions 140B upon which the model-specific permission 140A depends is not limited to any one of the models 150. Alternatively, one of the permissions 140A, 140B enjoyed by a corresponding one of the end users 110 may conflict with another of the permissions 140A, 140B not assigned to the corresponding one of the end users 110 in that the assigned one of the permissions 140A, 140B may depend upon the unassigned other one of the permissions 140A, 140B. To bring such conflicts to the attention of an administrator, a role explorer 100 may be provided in connection with the data analytics application 100.

More specifically, the role explorer 190 can be constructed for a selected one of the end users 110. In response to a selection of one of the end users 110, one or more queries 180 may be issued against the table 180 in order to identify all of the permissions 140A, 140B assigned to the selected one of the end users 110 and to organize in the role explorer 190 a listing of those of the permissions 140B that are instance-wide without regard to any particular one of the models 150, and also a listing of those of the permissions 140A that are specific to particular ones of the models 150 including a references to the particular ones of the models 150 for each of the corresponding permissions 140A.

As well, each of the permissions 140A, 140B may be tested for conflict by identifying an unassigned permission 140A, 140B upon which a corresponding one of the listed permissions 140A, 140B depends, but is not assigned to the selected one of the end users 110, and also one of the assigned permissions 140A, 140B operable upon the same data or similar data analytics operation as another of the assigned permissions 140A, 140B, with a scope that contradicts the another of the assigned permissions 140A, 140B so as to render the one of the assigned permissions 140A, 140B moot. Optionally, the role explorer 190 may also enumerate all roles 130 expressly assigned to the selected one of the end users 110 and all roles 130 implicitly assigned to the selected one of the end users 110 by virtue of nested one of the groups 120 to which the selected one of the end users 110 belongs.

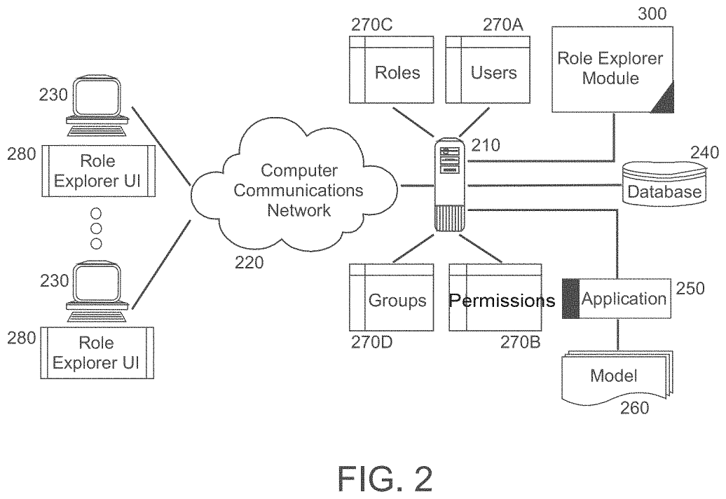

The process described in connection with FIG. 1 may be implemented in a data analytics data processing system. In further illustration, FIG. 2 schematically shows a data analytics data processing system configured for unified viewing of roles and permissions. As shown in FIG. 2, a host computing platform 210 includes one or more computers, each with memory and at least one processor, and is coupled to a database collection 240 of one or more data stores. A data analytics application 250 executes in the memory of the host computing platform 210 and is operable to construct different data models 260 for data in the database collection 240 and to provide data analytics operations operable upon the data models 260. As well, the data analytics application 250 moderates access to the data in the database collection 240 and the data analytics operations by different end users in user table 270A of the data analytics application 250 according to different permissions—both model-specific and instance-wide—stored in permissions table 270B and explicitly assigned to the different end users of the users table 270A, or implicitly assigned by virtual of roles of roles table 270C assigned to corresponding groups of groups table 270D to which the different end users of the users table 270A belong either directly or through nested groups of the groups table 270D.

Importantly, a role explorer module 300 is included with the data analytics application 250 and may be remotely accessed over computer communications network 220 through different role explorer user interfaces 280 rendered in respectively different client computing devices 230. The role explorer module 300 includes computer program instructions that when executing in the memory of the host computing platform 210, are operable to respond to a selection in the user interface 280 of one of the end users listed in the user table 270A, by displaying in the user interface 280 a list of associated permissions in the permissions table 270B, including both model-specific permissions and instance-wide permissions implicitly and explicitly assigned to the selected one of the end users. The program instructions additionally are operable to denote in the user interface 280 ones of the displayed list that are in conflict with another one of the permissions either by virtue of a dependency upon a permission not in the list, or by virtue of a different permission in the list whose scope neuters the scope of another permission in the list.

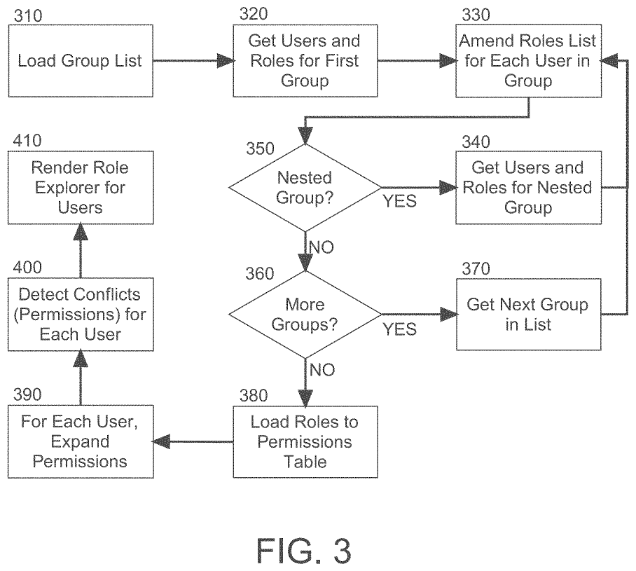

In even yet further illustration of the operation of the role explorer module 300, FIG. 3 is a flow chart illustrating a process for unified viewing of roles and permissions. Beginning in block 310, a list of groups of end users may be loaded and a set of users assigned to a first one of the groups retrieved in block 320, along with one or more roles assigned to the first one of the groups. In block 330, for each user assigned to the first one of the groups, a list of roles for the first one of the groups can be appended to a listing of roles assigned to the user. Then, in decision block 350, it can be determined if the first one of the groups includes one or more nested groups. If so, in block 340, the user or users and role or roles assigned to each one of the nested groups can be retrieved and the listing of roles for each of those users appended with the roles of the corresponding group and the parent group. The process can repeat for each nested group including one or more groups nested within a nested group and so forth.

In decision block 350, when the roles of all users of the first group, whether assigned explicitly or implicitly, are appended to the lists of the users, in block 360 it can be determined if further groups remain to be processed in the loaded group list. If so, the next group in the group list may be selected for processing in block 370 and the process returns to block 330 with the appending of the roles of the new group to the list of permissions assigned to each user. In decision block 360, when no further groups remain to be processed in the group list, in block 380, a roles table may be loaded correlating each different one of the roles with a set of one or more instance-wide or model-specific permissions. In block 300, for each user in the list, the assigned roles may be enumerated into a union of all permissions for the assigned roles based upon the loaded roles table. Then, in block 400, each of the permissions can be tested for conflict, either by identifying a dependency of a permission assigned to a user that requires a permission not assigned to the end user, or by identify two different permissions assigned to the user where one of the two different permissions has a scope that obviates the limitations of another of the two different permissions.

Finally, in block 410, the role explorer user interface may be rendered for a selected one of the end users so as to display a list of associated permissions, including both model-specific permissions and instance-wide permissions implicitly and explicitly assigned to the selected one of the end users, and also to denote ones of the displayed list that are in conflict with another one of the permissions either by virtue of a dependency upon a permission not in the list, or by virtue of a different permission in the list whose scope neuters the scope of another permission in the list.

The present disclosure may be included within a system, a method, a computer program product, or any combination thereof. The computer program product may include a computer readable storage medium or media having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer partly on the user's computer, as a stand-alone software package, partly on the user's computer and partly on a remote computer or entirely on the remote computer or server. Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular examples only and is not intended to be limiting of the disclosure. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form provided. Many modifications and variations will be apparent to those of ordinary skill in the art without departing from the scope and spirit of the disclosure. The example was chosen and described in order to best explain the principles of the disclosure and the practical application, and to enable others of ordinary skill in the art to understand the disclosure for various examples with various modifications as are suited to the particular use contemplated.

A number of implementations have been described. Nevertheless, it will be understood that various modifications may be made without departing from the spirit and scope of the disclosure. Accordingly, other implementations are within the scope of the following claims.

What is claimed is:

1. A method for the unified viewing of roles and permissions in a data processing system, the method comprising:
selecting, by data processing hardware, an end user accessing data in a data processing system;
determining, by the data processing hardware, an assigned role for the end user;
deconstructing, by the data processing hardware, the assigned role into a hierarchy of nested roles;
determining, by the data processing hardware, for each of the nested roles, corresponding permissions;
for each of the corresponding permissions, identifying, by the data processing hardware, dependent other permissions; and
generating and displaying, by the data processing hardware, a dashboard user interface displaying both the hierarchy of nested roles and also a listing of the corresponding permissions along with the identified dependent other permissions.

2. The method of claim 1, wherein the data processing system is a database driven application instance accessing a multiplicity of different data models for data in one or more underlying databases.

3. The method of claim 2, wherein the permissions include both instance-wide permissions for the application instance, and also model-specific permissions for specific ones of the data models.

4. The method of claim 3, further comprising:
identifying, by the data processing hardware, at least one contradiction in permissions wherein an instance-wide permission is granted for one of the assigned role and nested roles that overrides a model-specific permission for another one of the assigned role and nested roles; and
presenting, by the data processing hardware, an alert in the dashboard of the contradiction.

5. A data analytics data processing system configured for unified viewing of roles and permissions, the system comprising:
a host computing platform comprising one or more computers, each with memory and at least one processor;
a database management system coupled to the host computing platform, the database management system comprising one or more databases accessible through a common data access interface;
a data analytics application executing in the memory of the host computing platform, the data analytics application comprising a user interface providing a visualization of data analytics derived from database queries to the database management system through the common data access interface; and,
a unified roles and permissions viewing module comprising computer program instructions that, when executing in the memory of the host computing platform, is enabled to perform operations comprising:
selecting an end user accessing data in the data analytics application;
determining an assigned role for the end user;
deconstructing the assigned role into a hierarchy of nested roles;
determining for each of the nested roles, corresponding permissions;
for each of the corresponding permissions, identifying dependent other permissions; and
generating and displaying a dashboard in the user interface of the data analytics application, the dashboard displaying both the hierarchy of nested roles and also a listing of the corresponding permissions along with the identified dependent other permissions.

6. The system of claim 5, wherein the data analytics application accesses a multiplicity of different data models for data in one or more underlying ones of the databases.

7. The system of claim 6, wherein the permissions include both instance-wide permissions for the data analytics application, and also model-specific permissions for specific ones of the data models.

8. The system of claim 7, wherein the operations further comprise:
identifying at least one contradiction in permissions, wherein an instance-wide permission is granted for one of the assigned role and nested roles that overrides a model-specific permission for another one of the assigned role and nested roles; and
presenting an alert in the dashboard of the contradiction.

9. A computer program product for the unified viewing of roles and permissions in a data processing system, the computer program product including a computer readable storage medium having program instructions included therewith, the program instructions executable by a device to cause the device to perform a method including:
selecting an end user accessing data in a data processing system;
determining an assigned role for the end user;
deconstructing the assigned role into a hierarchy of nested roles;
determining for each of the nested roles, corresponding permissions;
for each of the corresponding permissions, identifying dependent other permissions; and
generating and displaying a dashboard user interface displaying both the hierarchy of nested roles and also a listing of corresponding permissions along with the identified dependent other permissions.

10. The computer program product of claim 9, wherein the data processing system is a database driven application instance accessing a multiplicity of different data models for data in one or more underlying databases.

11. The computer program product of claim 10, wherein the permissions include both instance-wide permissions for the application instance, and also model-specific permissions for specific ones of the data models.

12. The computer program product of claim 11, wherein the method further comprises:
identifying at least one contradiction in permissions wherein an instance-wide permission is granted for one of the assigned role and nested roles that overrides a model specific permission for another one of the assigned role and nested roles; and
presenting an alert in the dashboard of the contradiction.
